(19) United States
(12) Patent Application Publication
(10) Pub. No.: US 2026/0189144 A1
(43) Pub. Date: Jul. 2, 2026

(54) Controller for Twelve-Switch Zero Inductor Voltage Converter

(71) Applicant: Queen's University at Kingston, Kingston (CA)

(72) Inventors: Samuel Dylan Webb, Unionville (CA); Yan-Fei Liu, Kingston (CA)

(21) Appl. No.: 19/130,167

(22) PCT Filed: Nov. 15, 2023
(86) PCT No.: PCT/CA2023/051540

§ 371 Date: May 15, 2025

Related U.S. Application Data
(60) Provisional application No. 63/425,417, filed on Nov. 15, 2022.

(51) Int. Cl. H02M 3/158; H02M 1/00

(52) U.S. Cl. CPC H02M 3/158; H02M 1/0058; H02M 1/0095

(57) ABSTRACT

Controllers for a 12-switch zero inductor voltage stepdown converter implement at least one switching mode that decreases output voltages first and second phases of the converter to ½ the converter input voltage or less for corresponding first and second selected durations, wherein the output voltages of the first and second phases are phase shifted 180 degrees relative to each other. 5 In one mode the output voltages of the first and second phases are decreased to 0 V for the first and second durations. In another mode the output voltages of the first and second phases are decreased to ½ Vin for the first and second durations. An average output voltage of the converter is reduced in proportion to a time of the first and second selected durations, such that increased step-down ratios are achieved by the 12-switch ZIV converter.

### RELATED APPLICATION

This application claims the benefit of the filing date of Application No. 63/425,417 filed Nov. 15, 2022, the contents of which are incorporated herein by reference in their entirety.

### FIELD

This invention relates generally to controllers and control methods for DC-DC converters. In particular, this invention relates to control methods for a 12-switch zero inductor voltage converter to provide voltage regulation and a broad range of voltage stepdown ratios.

### BACKGROUND

Intermediate Bus Converters (IBCs) have attracted interest in recent years, particularly for 48 VDC to 12 VDC conversion in next-generation data center applications. Intermediate Bus Converters can be broadly categorized as non-regulated and regulated topologies. It is often advantageous to utilize a non-regulated topology if possible, due to the higher power density and efficiency that can be achieved. However, in some applications, voltage regulation may be required or desirable since it enables a Point-of-Load (POL) converter connected to the IBC to operate closer to an optimal point, thus increasing overall system efficiency. It is therefore desirable for a given circuit topology to have the option to provide output voltage regulation, as the efficiency and/or size penalty associated with this regulation in the IBC stage may in some cases be more than compensated by the improved efficiency/size of the POL stage.

### SUMMARY

According to one aspect of the invention there is provided a controller for a 12-switch zero inductor voltage (ZIV) converter, comprising: a processor that implements a control scheme for the 12-switch ZIV converter; wherein the 12-switch ZIV converter comprises an input point that receives an input DC voltage Vin, and a first phase output point V_{sw21} and a second phase output point V_{sw22} connected together at a common output point; wherein the control scheme provides voltage regulation of the 12-switch ZIV converter by implementing at least one switching mode that decreases an output voltage of the first phase output point V_{sw21} to 1/2 Vin or less for a first selected duration and decreases an output voltage of the second phase output point V_{sw22} to 1/2 Vin or less for a second selected duration, and the output voltages of the first and second phase output points are phase shifted 180 degrees relative to each other.

In one embodiment a time period of the first selected duration is substantially the same as a time period of the second selected duration.

In one embodiment the at least one switching mode decreases the output voltage at the first phase output point to approximately 0 V for the first selected duration and decreases the output voltage at the second phase output point to approximately 0 V for the second selected duration; wherein an average output voltage at the common output point is reduced in proportion to a time of the first and second selected durations; wherein increased step-down ratios are achieved by the 12-switch ZIV converter. In one embodiment the output voltage at the common output point is less than 1/4 Vin.

In one embodiment the at least one switching mode decreases the output voltage at the first phase output point to approximately 1/2 Vin for the first selected duration and decreases the output voltage at the second phase output point to approximately 1/2 Vin for the second selected duration; wherein an average output voltage at the common output point is increased in proportion to a time of the first and second selected durations; wherein decreased step-down ratios are achieved by the 12-switch ZIV converter. In one embodiment the output voltage at the common output point is greater than 1/4 Vin.

In one embodiment the controller comprises a driver that receives the control scheme and generates drive signals for the switches of the 12-switch ZIV converter.

Another aspect of the invention relates to a 12-switch ZIV converter comprising a controller as described herein.

Another aspect of the invention relates to a method for controlling a 12-switch zero inductor voltage (ZIV) converter, comprising: using a processor to implement a control scheme for the 12-switch ZIV converter; wherein the 12-switch ZIV converter comprises an input point that receives an input DC voltage Vin, and a first phase output point V_{sw21} and a second phase output point V_{sw22} connected together at a common output point; wherein the control scheme provides voltage regulation of the 12-switch ZIV converter by implementing at least one switching mode that decreases an output voltage of the first phase output point V_{sw21} to 1/2 Vin or less for a first selected duration and decreases an output voltage of the second phase output point V_{sw22} to 1/2 Vin or less for a second selected duration, and the output voltages of the first and second phase output points are phase shifted 180 degrees relative to each other.

In one embodiment a time period of the first selected duration is substantially the same as a time period of the second selected duration.

In one embodiment the at least one switching mode decreases the output voltage at the first phase output point to approximately 0 V for the first selected duration and decreases the output voltage at the second phase output point to approximately 0 V for the second selected duration; wherein an average output voltage at the common output point is reduced in proportion to a time of the first and second selected durations; wherein increased step-down ratios are achieved by the 12-switch ZIV converter. In one embodiment the output voltage at the common output point is less than 1/4 Vin.

In one embodiment the at least one switching mode decreases the output voltage at the first phase output point to approximately 1/2 Vin for the first selected duration and decreases the output voltage at the second phase output point to approximately 1/2 Vin for the second selected duration; wherein an average output voltage at the common output point is increased in proportion to a time of the first and second selected durations; wherein decreased step-down ratios are achieved by the 12-switch ZIV converter. In one embodiment the output voltage at the common output point is greater than 1/4 Vin.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a schematic diagram of a 12-switch ZIV converter according to the prior art.

FIG. 2 is a PWM timing diagram for the 12-switch ZIV converter in conventional 4:1 stepdown operation, according to the prior art.

FIGS. 3A-3D are schematic diagrams illustrating operation of the 12-switch ZIV converter in states A-D, according to the prior art.

FIGS. 4A-4C are schematic diagrams of equivalent circuits of the 12-switch ZIV converter during states A-D, according to the prior art.

FIG. 5 is a schematic diagram of one phase of a 12-switch ZIV converter operating in a Freewheeling mode, according to an embodiment.

FIG. 6A is a timing diagram for the Freewheeling mode shown in FIG. 5, according to one embodiment.

FIGS. 6B-6E are voltage waveforms for the Freewheeling mode shown in FIGS. 5 and 6A, for a 5:1 voltage stepdown, according to an embodiment.

FIGS. 7A and 7B are schematic diagrams of one phase of a 12-switch ZIV converter operating in a Bypass mode, according to an embodiment.

FIG. 8A is a timing diagram for the Bypass mode shown in FIGS. 7A and 7B, according to one embodiment.

FIGS. 8B-8E are voltage waveforms for the Bypass mode shown in FIGS. 7A, 7B, and 8A, for a 10:3 voltage stepdown, according to an embodiment.

### DETAILED DESCRIPTION OF EMBODIMENTS

Disclosed are voltage regulation and control methods and controllers for a 12-Switch Zero Inductor Voltage (ZIV) DC-DC converter. The 12-Switch ZIV converter as previously described (U.S. Pat. No. 11,043,899) provides an unregulated 4:1 stepdown ratio between the input voltage and the output voltage. Control methods described herein allow for the step-down ratio to be modified to any value between 2:1 stepdown and 0 V output, greatly extending the output voltage range and expanding applications for the ZIV converter. Embodiments may be implemented without significantly increasing losses of the ZIV converter, and the only design compromise required is a larger output inductor value. Notably the output inductor value is still significantly smaller than the output inductor of existing PWM-based converter topologies such as a buck converter.

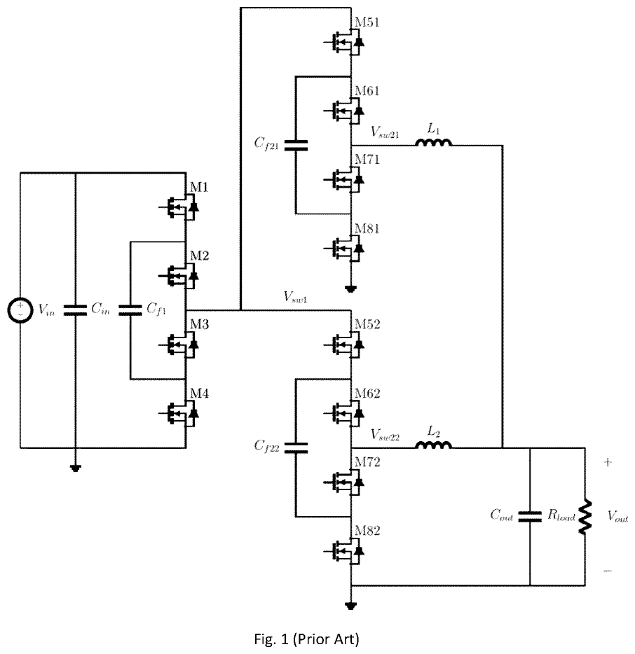

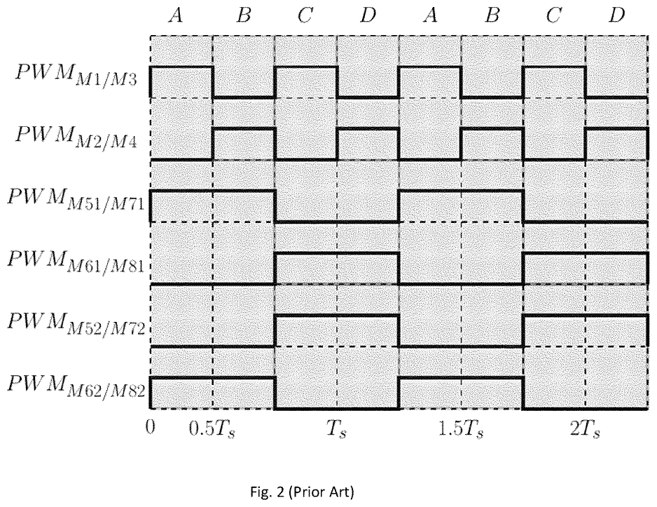

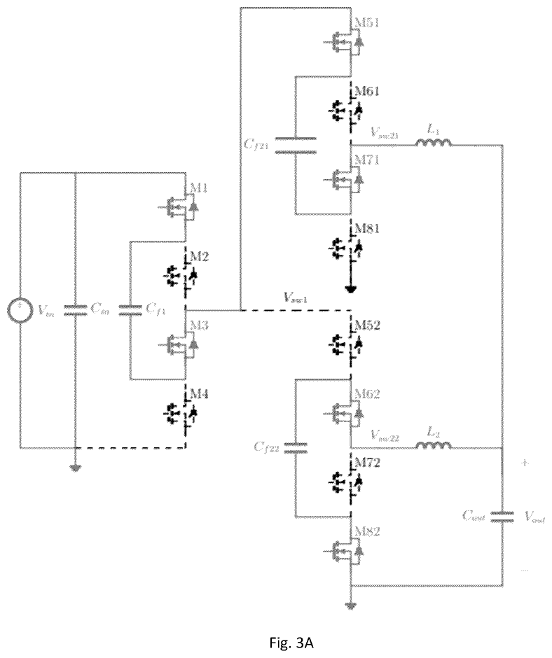

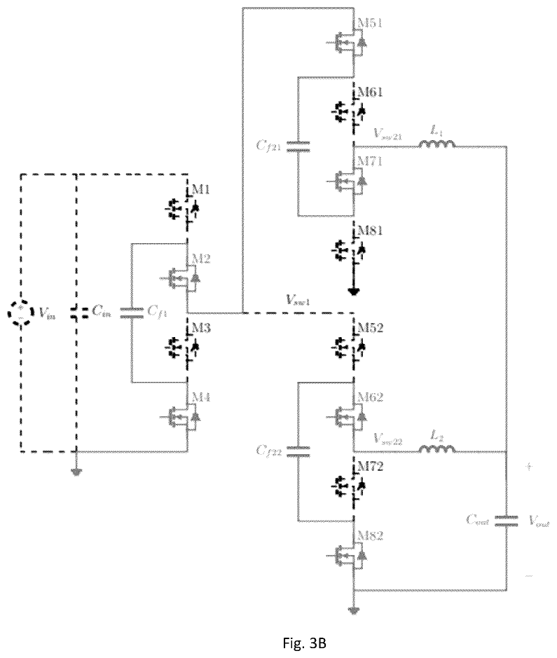

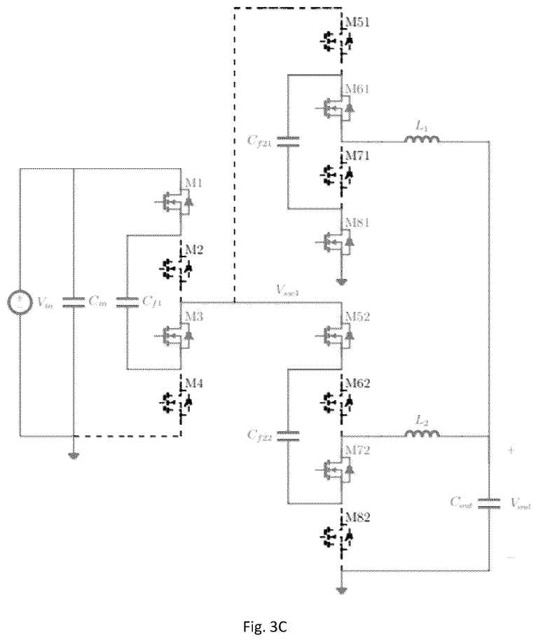

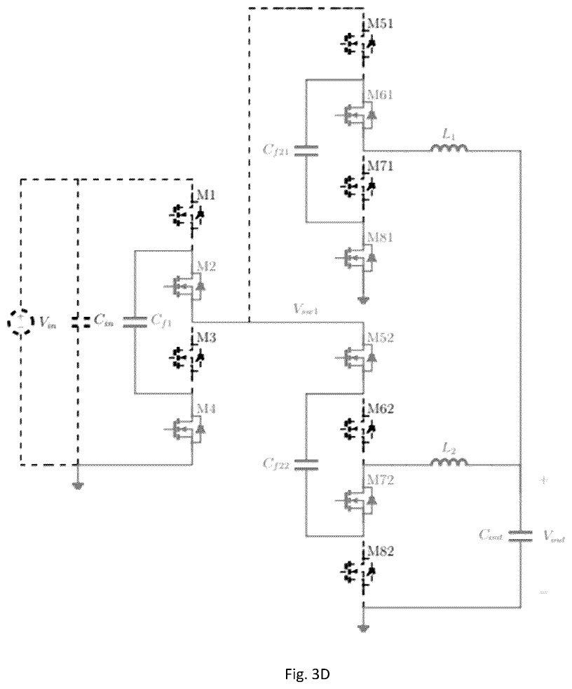

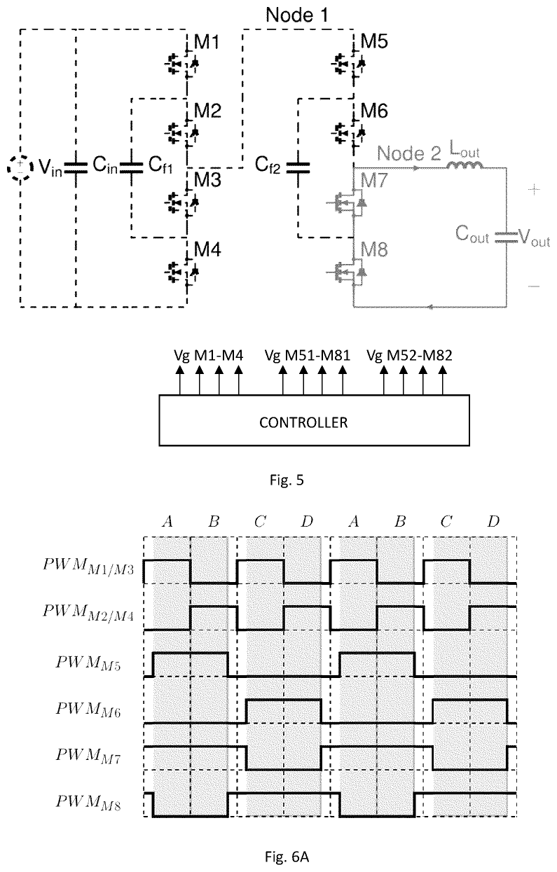

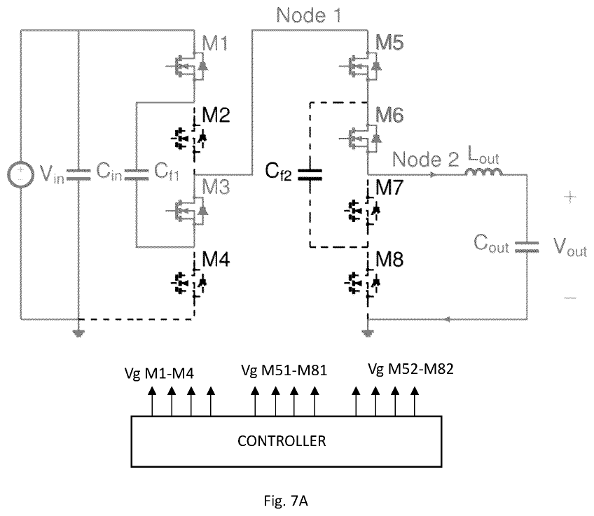

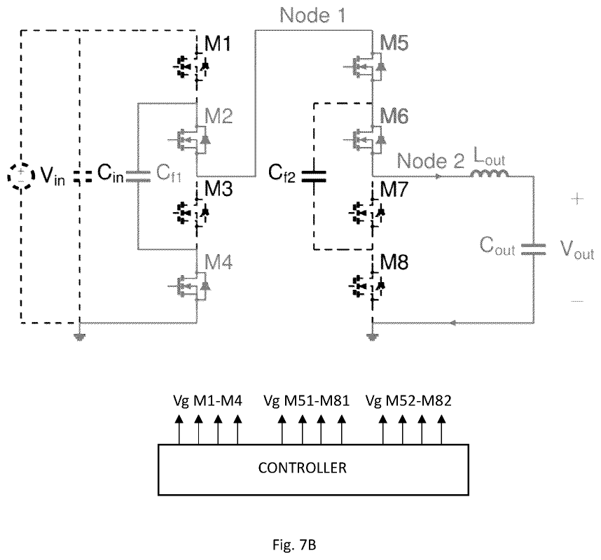

FIG. 1 is a schematic diagram of a 12-Switch Zero Inductor Voltage converter. The circuit includes a first stage with an input capacitor Cᵢₙ, flying capacitor C_{f1}, switches M1-M4, and two second stage circuits connected together in parallel with a common second stage output. The first second stage circuit includes a flying capacitor C_{f21}, switches M51-M81, and an output inductor L₁. The second second stage circuit includes a flying capacitor C_{f22}, switches M52-M82, and an output inductor L₂. The common second stage output is connected to an output capacitor Cₒᵤₜ for connection to a load. A controller, e.g., as shown in FIGS. 5, 7A, and 7B, generates drive signals for the switches (e.g., MOSFETs) according to a control scheme. A control scheme based on pulse width modulation (PWM) for this converter is shown in FIG. 2. This PWM scheme results in four operating states for the converter, shown in FIGS. 3A-3D. To simplify the description of the circuit operation, the phase involving switches M1, M2, M3, M4, M51, M61, M71, and M81 will be described in detail, with the understanding that in the operation of the phase involving switches M1, M2, M3, M4, M52, M62, M72, and M82 the operation of M52, M62, M72, and M82 is 180 degrees phase shifted relative to M51, M61, M71 and M81 and thus follows the same principles. In FIGS. 3A-3D, parts of the circuit that do not function during each state are shown in dashed lines.

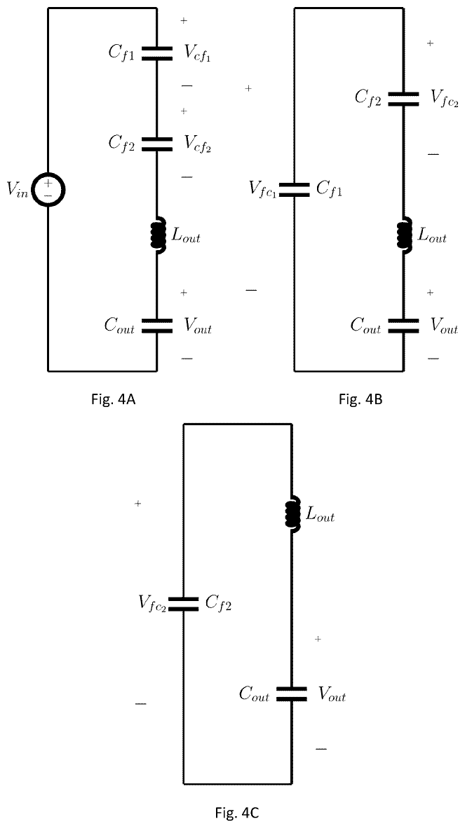

Referring to FIG. 3A, in State A, switches M1, M3, M51 and M71 are turned on. Both flying capacitors C_{f1} and C_{f21} are charging in this state. The converter equivalent circuit for State A is represented in FIG. 4A.

In State B switches M2, M4, M51 and M71 are turned on. The first stage flying capacitor C_{f1} is now discharging, while the second stage flying capacitor C_{f21} continues to charge. The converter equivalent circuit for State B is represented in FIG. 4B.

In States C and D switches M61 and M81 are turned on. With M51 turned off the second stage is now decoupled from the first stage, allowing for the mirrored operation of the M52-M82 stage to proceed, and making States C and D identical from the perspective of the M51-M81 stage. The second stage flying capacitor C_{f21} is now discharging. The converter equivalent circuit for States C and D is represented in FIG. 4C.

As noted above, operation of the 12-Switch ZIV converter according to this prior scheme provides an unregulated 4:1 step down ratio between the input voltage and the output voltage, which limits the range of applications where it may be used.

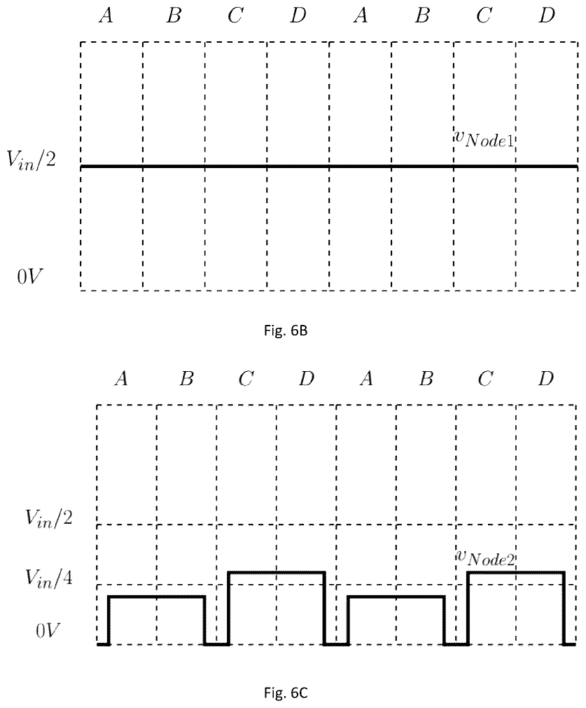

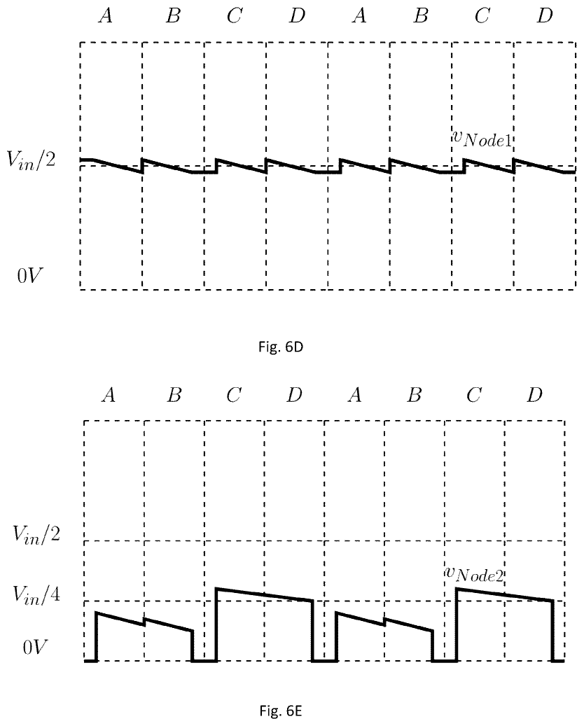

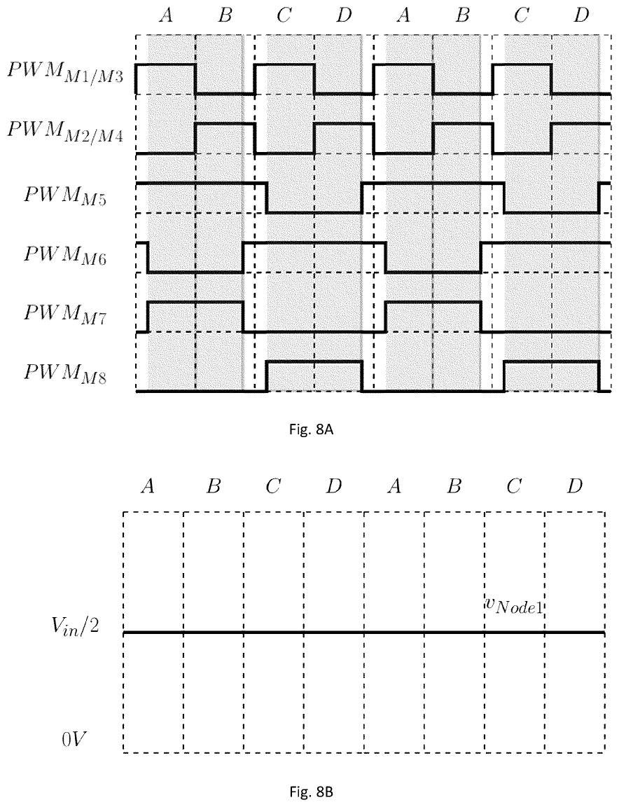

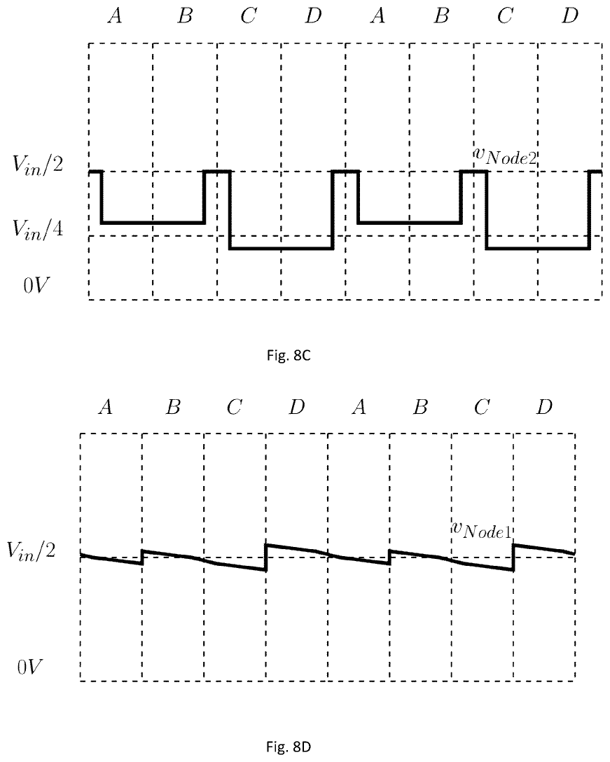

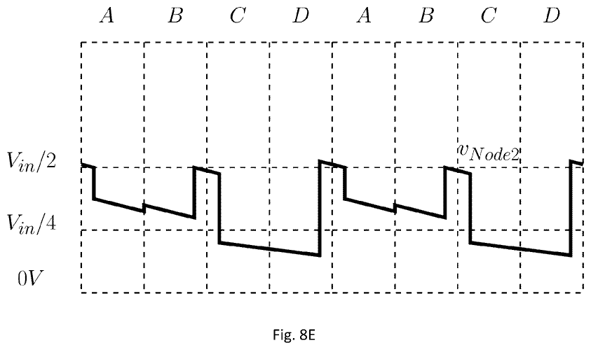

Embodiments described herein overcome limitations of the conventional 12-Switch ZIV converter by achieving output voltage regulation. According to embodiments, one or more additional switching modes may be implemented by the controller. For example, in one embodiment an additional switching mode, referred to as the Freewheeling mode, the output voltage of the converter at V_{sw21} (i.e., the junction of switches M61 and M71, see FIG. 1) will be approximately 0 V for a selected duration and the output voltage of the converter at V_{sw22} (i.e., the junction of switches M62 and M72, see FIG. 1) will be approximately 0 V for the selected duration but phase-shifted 180 degrees from the output at V_{sw21}. The waveform of V_{sw21} under this Freewheeling mode is shown in FIGS. 6C and 6E as VNode2. The introduction of this mode allows for the average output voltage before the LC output filter (L₁ and Cₒᵤₜ, L₂ and Cₒᵤₜ) to be reduced proportional to the time spent (i.e., duration) in the Freewheeling mode, allowing for increased step-down ratios to be achieved relative to the prior control scheme. As another example, in another additional mode, referred to as the Bypass mode, the output voltage of the converter at V_{sw21} will be approximately 1/2 Vin for a selected duration, and the output voltage of the converter at V_{sw22} will be approximately 1/2 Vin for the selected duration but phase-shifted 180 degrees from the output at V_{sw21}. The waveform of V_{sw22} under this Bypass mode is shown in FIGS. 8C and 8E as VNode2. The introduction of this mode allows for the average output voltage before the LC output filter (L₁ and Cₒᵤₜ, L₂ and Cₒᵤₜ) to be increased proportional to the time spent in the Bypass mode, allowing for decreased step-down ratios to be achieved relative to the prior control scheme. In certain embodiments both the Freewheeling mode and the Bypass mode may be implemented. For example, for a particular output voltage, such as, e.g., 1/5 Vin, both the Freewheeling mode and the Bypass mode may be used to generate Vo=1/5 Vin. Other embodiments may be optimized to minimize the output inductor value requirement. For example, in embodiments where the required output voltage is less than about ¼ of the input voltage (such as, e.g., 1/5 Vin), only the Freewheeling mode is used. Alternatively, for example, in embodiments where the required output voltage is greater than about ¼ of the input voltage (such as, e.g., 1/3 Vin), only the Bypass mode is used.

Thus, embodiments include control methods and controllers that implement one or more additional switching modes in a 12-Switch ZIV converter to enable voltage regulation and wider ranges of voltage conversion ratios. Embodiments may include a PWM control scheme. The control methods and controllers may perform one or more operations such as, for example, but not limited to, input and/or output voltage and/or current sensing, generating voltage and/or current reference signals, power factor correction, and generating drive signals for switches (e.g., MOSFETs, IGBTs, etc.) of the converter.

As used herein, the terms “substantially” and “approximately” mean that the recited characteristic, parameter, and/or value need not be achieved exactly, but that deviations or variations, including for example, those due to component tolerances, measurement error, measurement accuracy limitations and other factors known to those of ordinary skill in the art may occur in amounts that do not preclude or detract from the effect or result the characteristic was intended to provide. A characteristic, feature, or value may be one that is practically obtained (e.g., substantially 0 V) and is close to but not exactly as may be derived theoretically (e.g., 0 V).

The controller may include a processing device (“processor”) and a memory device. The processor may be, for example, a computer, or a digital controller such as a microcontroller unit (MCU), field programmable gate array (FPGA), etc. The processor may include processing capabilities as well as an input/output (I/O) interface through which the processor may receive a plurality of input signals (e.g., voltage and/or current sensing signals, voltage and/or current reference signals), and generate a plurality of output signals (e.g., gate drive signals for switches of the converter). The memory is provided for storage of data and instructions or code (i.e., an algorithm, such as a control algorithm, control logic, software, etc.) executable by the processor. The memory may include various forms of non-volatile (i.e., non-transitory) memory including flash memory or read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM). A converter may include a driver circuit or device to interface between outputs of the controller and the control (e.g., gate) terminals of the semiconductor switches.

The memory stores executable code including control logic which is configured to control the overall operation of a converter in accordance with a desired control scheme, including a scheme for one or more additional switching modes as described herein. For example, the control logic, when executed by the processor, is configured to generate, in response to one or more input signals, the various drive signals for the switches of the converter. The control logic may include programmed logic blocks to implement specific functions, for example, including without limitation, zero crossing detection, error amplifier, pulse width modulation (PWM), power factor correction (PFC), zero voltage switching (ZVS), rms voltage and/or current calculator, operating mode control logic, and startup and/or shut down strategy. The memory may also store features, e.g., a lookup table that may be accessed by the control logic. Non-limiting examples of control strategies, or parts thereof, that may be implemented separately or in combination in controllers according to embodiments described herein include a Freewheeling mode and a Bypass mode, examples of which are shown in waveforms of FIGS. 6A-6E and 8A-8E.

### Freewheeling Operation

To simplify the description of the control of the circuit operation, the first phase involving switches M1, M2, M3, M4, M51, M61, M71 and M81 will be described in detail, with the understanding that the operation of the second phase involving M52, M62, M72 and M82 is 180 degrees phase shifted to M51, M61, M71 and M81 and thus follows the same principles. A simplified circuit is shown in FIG. 5 where the second stage components are generically labelled, wherein the switches M5-M8, the flying capacitor C_{f2}, and the output inductor Lout represent the second stage components of the first or second phase, and Node 2 refers to the node at either V_{sw21} or at V_{sw22}. FIG. 5 also shows a controller that provides the control signals to all 12 switching devices (Vg M1-M4, Vg M51-M81, Vg M52-M82). It will be appreciated that the switches may be implemented with any suitable switching device such as MOSFET, IGBT, etc. In the Freewheeling mode only switches M7 and M8 are turned on. As a result, the voltage at Node 2 (i.e., V_{sw21} or V_{sw22} FIG. 6B) is equal to approximately 0 V. In a practical implementation Node 2 will have a very small negative voltage due to the on-state resistance of M7 and M8, proportional to the load current, but this is neglected in this analysis.

According to embodiments, switches may be turned on actively by applying suitable switching signals or passively by allowing conduction through body diodes (assuming the switches are implemented as MOSFETs or another switch with a reverse conducting diode). However, to achieve the full range of voltage regulation M7 and M8 should be turned on actively, rather than allowed to conduct through their body diodes. That is, the full range of regulation may be achieved if the Node 2 voltage is pulled down to approximately 0 V. Without turning on M7 and M8, this is only achieved when the body diodes become forward biased which requires positive inductor current. Therefore, if M7 and M8 are not actively turned on, regulation cannot be achieved at light/no-load condition. If M7 and M8 are turned on, however, then the Node 2 voltage is pulled down to close to 0 V, allowing for regulation regardless of output current levels.

By including a Freewheeling mode as described herein the converter output voltage may be regulated to achieve higher conversion ratios than 4:1 (in other words, the output voltage is lower than 1/4 Vin) by increasing the amount of time in the 0 V output state. The output voltage of the converter including the Freewheeling mode can then be given by equations 1.1 and 1.2 where tₐ, t_{b}, and t_{cd} are the times spent in each switching state A, B, C and D, respectively, t_{fw} is the time spend in the Freewheeling mode, and T_{sw} is the switching period:

$${V}_{out} = \frac{\frac{{V}_{in}}{4} ( {t}_{a} + {t}_{b} + {t}_{cd} ) + 0 {t}_{fw}}{{T}_{sw}} \qquad ( 1.1 )$$

$${V}_{out} = \frac{\frac{{V}_{in}}{4} ( {t}_{a} + {t}_{b} + {t}_{cd} )}{{T}_{sw}} \qquad ( 1.2 )$$

In some implementations it may be desirable to keep the ratio of tₐ, t_{b}, and t_{cd} equal to the conventional operation of the ZIV converter to minimize the inductor current ripple. For example, tₐ should be equal to t_{b} and t_{cd} should be equal to tₐ+t_{b}. For example, from equation 1.2, to achieve 60 V to 12 V conversion (5:1 stepdown ratio) the sum of tₐ, t_{b} and t_{cd} should then be 80% of the total switching period, with the remaining 20% of the switching period being the Freewheeling mode. An example of a PWM timing diagram for a 5:1 stepdown ratio is given in FIG. 6A. FIGS. 6B and 6C show the voltage waveforms at Node 1 and Node 2, respectively, during operation of Freewheeling mode, when the ripple voltage across flying capacitors is assumed to be zero. FIGS. 6D and 6E show the voltage waveforms at Node 1 and Node 2, respectively, during operation of Freewheeling mode, when the ripple voltage across flying capacitors is considered. Of course, other implementations are possible, such as operating with only one Freewheeling mode for 20% of the switching period, or operating with four Freewheeling modes for 5% of the switching period. Such different operations will result in the same output voltage, but different output inductor ripple currents as the inductor voltage during the Freewheeling time is much larger than in State A, B, C, or D. Therefore, using multiple shorter Freewheeling periods reduces the inductor current ripple, and hence reduces the size of the output inductor, but becomes increasingly complex in terms of the PWM requirements.

### Bypass Operation

In order to simplify the description of the circuit operation, the first phase involving switches M1, M2, M3, M4, M51, M61, M71 and M81 will be described in detail, with the understanding that the operation of the second phase switches M52, M62, M72, and M82 is exactly 180 degrees phase shifted to M51, M61, M71 and M81 and thus follows the same principles. A simplified circuit is shown in FIGS. 7A and 7B, representing the Bypass operation modes according to one embodiment. In FIGS. 7A and 7B the second stage components are generically labelled, wherein the switches M5-M8, the flying capacitor C_{f2}, and the output inductor Lout represent the second stage components of the first or second phase, and Node 2 refers to the node at either V_{sw21} or at V_{sw22}. FIGS. 7A and 7B also show a controller that provides the control signals to all 12 switching devices (Vg M1-M4, Vg M51-M81, Vg M52-M82).

In this operating mode the top two switches of the second stage M5 and M6 are turned on and as a result the flying capacitor C_{f2} of the second converter stage is effectively bypassed. The operation of the first stage of the converter remains unchanged from the conventional operation, resulting in two Bypass modes, but in both modes the voltage output at Node 2 will be equal to 1/2 Vin neglecting capacitor ripple. This operation is similar to the Freewheeling operation previously discussed, with the average of State A, B, C, and D again being equal to a 4:1 stepdown ratio, but in this case the Bypass operating modes output a 2:1 stepdown ratio, rather than OV. The equation for the output voltage of the converter utilizing the Bypass mode is given by equation 2 where tₐ, to, and t_{cd} are the times spent in each switching state respectively, top is the time spent in the Bypass operating mode, and T_{sw} is the switching period:

$${V}_{out} = \frac{\frac{{V}_{in}}{4} ( {t}_{a} + {t}_{b} + {t}_{cd} ) + \frac{{V}_{in}}{2} {t}_{bp}}{{T}_{sw}} \qquad ( 2 )$$

From equation 2 for an example of 40 V to 12 V conversion (10:3 stepdown ratio, or Vo=Vin/3) the sum of tₐ, t_{b}, and t_{cd} is 80% of the switching cycle, with the remaining 20% of the switching cycle in the Bypass operating modes. In some implementations it may be desirable to keep the ratio of tₐ, t_{b}, and ted equal to that of the conventional ZIV converter. In such embodiments, tₐ should be equal to t_{b} and t_{dc} should be equal to tₐ+t_{b}. An example of a PWM timing diagram that may be used to achieve this is presented in FIG. 8A. FIGS. 8B and 8C show the voltage waveforms at Node 1 and Node 2, respectively, during operation with Bypass mode, when the ripple voltage across the flying capacitors is assumed to be zero. FIGS. 8D and 8E show the voltage waveform at Node 1 and Node 2, respectively, during operation with Bypass mode, when the ripple voltage across the flying capacitors is considered. Equivalently to the Freewheeling operating mode, this Bypass mode can be implemented through several different PWM timings. Increasing the number of Bypass modes while decreasing their duration will again reduce inductor current ripple, allowing for a smaller output inductor, while increasing PWM complexity.

### Detailed Implementation

Two examples are provided to further describe the regulation. The first example is (I) Freewheeling mode for a 60 V input to 12 V output (i.e., a 5:1 stepdown ratio). The second example is (II) Bypass mode for a 40 V input to 12 V output (i.e., a 3:1 stepdown ratio). These values are selected as a typical regulation range for 48 V nominal input is 40 V to 60 V.

(I) From equation 1.2 for 60 V to 12 V operation:

$$12 = \frac{\frac{60}{4} ( {t}_{a} + {t}_{b} + {t}_{cd} )}{{T}_{s w}} \\ \frac{{t}_{a} + {t}_{b} + {t}_{cd}}{{T}_{sw}} = \frac{48}{60} = 80 \%$$

And it follows that:

$${t}_{fw} = {T}_{sw} - ( {t}_{a} + {t}_{b} + {t}_{cd} ) = 20 \%$$

FIG. 6A shows an example of a PWM implementation of these duty cycles for a Freewheeling mode, where the freewheeling time (t_{fw}) is split into two 10% freewheeling periods to reduce the inductor ripple current. In practical cases this also reduces the complexity of the PWM implementation. Considering the eight switches of one phase of the 12-Switch ZIV converter module (as shown in FIG. 5) the PWM signals for each switch may be described as follows. Switches M1-M4 operate at 50% duty cycle (FIG. 2). Switch M5 operates with 40% duty cycle. Switch M8 operates with 60% duty cycle. Switch M6 operates with 40% duty cycle, and is 180 degrees phase shifted relative to M5. Switch M7 operates with 60% duty cycle and is 180 degrees phase shifted relative to M8.

(II) From equation 2 for 40 V to 12 V operation:

$$12 = \frac{\frac{40}{4} ( {t}_{a} + {t}_{b} + {t}_{cd} ) + \frac{40}{2} ( {t}_{bp} )}{{T}_{sw}}$$

The bypass time is also directly related to the other timings by equation (3):

$${t}_{bp} = {T}_{sw} - ( {t}_{a} + {t}_{b} + {t}_{cd} ) \qquad ( 3 )$$

### Then:

$$12 {T}_{sw} = 10 ( {t}_{a} + {t}_{b} + {t}_{cd} ) + 20 {T}_{sw} - 20 ( {t}_{a} + {t}_{b} + {t}_{cd} ) \\ - 8 {T}_{sw} = - 10 ( {t}_{a} + {t}_{b} + {t}_{cd} ) \\ \frac{{t}_{a} + {t}_{b} + {t}_{cd}}{{T}_{sw}} = 80 \%$$

It follows that:

$${t}_{bp} = {T}_{sw} - ( {t}_{a} + {t}_{b} + {t}_{cd} ) = 20 \%$$

FIG. 8A shows an embodiment of a PWM implementation of these duty cycles for a 3:1 stepdown, where the bypass time (top) is split into two 10% bypass periods to reduce the inductor ripple current. In a practical implementation this also reduces the complexity of PWM implementation. Considering the eight switches of one phase of the 12-Switch ZIV converter module (as shown in FIGS. 7A, 7B) the PWM signals for each switch may be described as follows. Switches M1-M4 operate at 50% duty cycle (FIG. 2). Switch M5 operates with 60% duty cycle. Switch M8 operates with 40% duty cycle. Switch M6 operates with 60% duty cycle, and is 180 degrees phase shifted relative to M5. Switch M7 operates with 40% duty cycle and is 180 degrees phase shifted relative to M8.

Note that for both Bypass and Freewheeling operation the switches share the following relationship for a given duty cycle D:

$$M 5 = M 7 = D M 6 = M 8 = 1 - D$$

M7 is always 180 degrees phase shifted relative to M5, and M8 is always 180 degrees phase shifted relative to M8. The conventional 4:1 operation for the ZIV converter also obeys this relationship, making practical PWM implementation relatively straightforward with only additional duty cycle control needed. Examples include Bypass operation when D>50% and Freewheeling operation when D<50%. D=50% for 4:1 conventional operation.

All cited documents are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

1. A controller for a 12-switch zero inductor voltage (ZIV) converter, comprising:
a processor that implements a control scheme for the 12-switch ZIV converter;
wherein the 12-switch ZIV converter comprises an input point that receives an input DC voltage Vin, and a first phase output point V_{sw21} and a second phase output point V_{sw22} connected together at a common output point;
wherein the control scheme provides voltage regulation of the 12-switch ZIV converter by implementing at least one switching mode that decreases an output voltage of the first phase output point V_{sw21} to 1/2 Vin or less for a first selected duration and decreases an output voltage of the second phase output point V_{sw22} to 1/2 Vin or less for a second selected duration, and the output voltages of the first and second phase output points are phase shifted 180 degrees relative to each other.

2. The controller of claim 1, wherein a time period of the first selected duration is substantially the same as a time period of the second selected duration.

3. The controller of claim 1, wherein the at least one switching mode decreases the output voltage at the first phase output point to approximately 0 V for the first selected duration and decreases the output voltage at the second phase output point to approximately 0 V for the second selected duration;
wherein an average output voltage at the common output point is reduced in proportion to a time of the first and second selected durations;
wherein increased step-down ratios are achieved by the 12-switch ZIV converter.

4. The controller of claim 1, wherein the at least one switching mode decreases the output voltage at the first phase output point to approximately 1/2 Vin for the first selected duration and decreases the output voltage at the second phase output point to approximately 1/2 Vin for the second selected duration;
wherein an average output voltage at the common output point is increased in proportion to a time of the first and second selected durations;
wherein decreased step-down ratios are achieved by the 12-switch ZIV converter.

5. The controller of claim 3, wherein the output voltage at the common output point is less than 1/4 Vin.

6. The controller of claim 4, wherein the output voltage at the common output point is greater than 1/4 Vin.

7. The controller of claim 1, comprising a driver that receives the control scheme and generates drive signals for the switches of the 12-switch ZIV converter.

8. A 12-switch ZIV converter comprising the controller of claim 1.

9. A method for controlling a 12-switch zero inductor voltage (ZIV) converter, comprising:
using a processor to implement a control scheme for the 12-switch ZIV converter;
wherein the 12-switch ZIV converter comprises an input point that receives an input DC voltage Vin, and a first phase output point V_{sw21} and a second phase output point V_{sw22} connected together at a common output point;
wherein the control scheme provides voltage regulation of the 12-switch ZIV converter by implementing at least one switching mode that decreases an output voltage of the first phase output point V_{sw21} to 1/2 Vin or less for a first selected duration and decreases an output voltage of the second phase output point V_{sw22} to 1/2 Vin or less for a second selected duration, and the output voltages of the first and second phase output points are phase shifted 180 degrees relative to each other.

10. The method of claim 9, wherein a time period of the first selected duration is substantially the same as a time period of the second selected duration.

11. The method of claim 9, wherein the at least one switching mode decreases the output voltage at the first phase output point to approximately 0 V for the first selected duration and decreases the output voltage at the second phase output point to approximately 0 V for the second selected duration;
wherein an average output voltage at the common output point is reduced in proportion to a time of the first and second selected durations;
wherein increased step-down ratios are achieved by the 12-switch ZIV converter.

12. The method of claim 9, wherein the at least one switching mode decreases the output voltage at the first phase output point to approximately 1/2 Vin for the first selected duration and decreases the output voltage at the second phase output point to approximately 1/2 Vin for the second selected duration;
wherein an average output voltage at the common output point is increased in proportion to a time of the first and second selected durations;
wherein decreased step-down ratios are achieved by the 12-switch ZIV converter.

13. The controller of claim 11, wherein the output voltage at the common output point is less than 1/4 Vin.

14. The controller of claim 12, wherein the output voltage at the common output point is greater than 1/4 Vin.
